(19) United States
(12) Patent Application Publication
(10) Pub. No.: US 2025/0100528 A1
(43) Pub. Date: Mar. 27, 2025

(54) BRAKE SYSTEM FOR A MOTOR VEHICLE, AND ELECTROHYDRAULIC BRAKE SYSTEM

(71) Applicant: Continental Automotive Technologies GmbH, Hannover (DE)

(72) Inventors: Thorsten Ullrich, Gernsheim (DE); Martin Baechle, Kelkheim (DE)

(73) Assignee: Continental Automotive Technologies GmbH, Hannover (DE)

(21) Appl. No.: 18/832,851

(22) PCT Filed: Dec. 20, 2022
(86) PCT No.: PCT/DE2022/200307

§ 371 Date: Jul. 24, 2024

(30) Foreign Application Priority Data
Jan. 24, 2022 (DE) 10 2022 200 751.4
Jun. 14, 2022 (DE) 10 2022 205 982.4

(51) Int. Cl. B60T 13/68; B60T 8/171; B60T 8/172; B60T 13/14; B60T 13/74

(52) U.S. Cl. CPC B60T 13/686; B60T 8/171; B60T 8/172; B60T 13/148; B60T 13/745; B60T 13/746; B60T 2220/04; B60T 2270/402; B60T 2270/404; B60T 2270/413; B60T 2270/414; B60T 2270/82

(57) ABSTRACT

A brake system for a motor vehicle includes an electrohydraulic partial brake system, an electromechanical partial brake system, a redundant power supply, and an actuating device (124). The actuating device is configured to determine an actuation signal quantifying a brake request as a result of an actuation by a vehicle driver. The brake system includes a brake control unit (118) with at least two mutually independent partitions. Both partitions are each configured for controlling the electromechanical partial brake system and the electrohydraulic partial brake system on the basis of an actuating signal received from the actuating device.

### CROSS-REFERENCE TO RELATED APPLICATIONS

This application is a national stage application, filed under 35 U.S.C. § 371, of International Patent Application No. PCT/DE2022/200307, filed on Dec. 20, 2022,which claims priority to German patent application No. 10 2022 200 761.4, filed Jan. 24, 2022, and German patent application No. 10 2022 205 982.4, filed Jun. 14, 2022, each of which is incorporated by reference.

### TECHNICAL FIELD

The technical field relates to a brake system for a motor vehicle having an electrohydraulic partial brake system and an electromechanical partial brake system.

### BACKGROUND

Brake systems having an electrohydraulic partial brake system and an electromechanical partial brake system are known from the prior art and are described, for example, in DE 10 2012 217 825 A1. A first partial brake system with electrohydraulically actuated wheel brakes acts on a front axle of the vehicle here, while a second partial brake system with electromechanical wheel brakes acts on the rear axle of the vehicle.

The system architecture described therein provides that the electrohydraulic partial brake system of the front axle has a mechanical fallback level, with the result that, in the event of failure of an electrical or electronic component, braking via the front wheel brakes is still possible. To this end, when the brake pedal is actuated, brake fluid volume from a brake master cylinder is displaced directly into the hydraulic wheel brakes of the front axle, with the result that a corresponding brake force can also still be built up.

This system architecture is limited to non-automated driving (SAE level≤2) and, in particular, to motor vehicles that have a brake pedal mechanically coupled to the brake system. If this system architecture were used in conjunction with automated driving functions (SAE level>2) or in conjunction with an electronic brake pedal, i.e. a brake pedal which does not have a mechanical fallback level by means of a direct mechanical connection between the brake pedal and the master cylinder, the disadvantage would be that a single electrical fault in the electrohydraulic partial brake system would already lead to a degradation of the brake function to braking solely by way of the electromechanically decelerated rear axle.

Therefore, there remains an opportunity to provide a brake system with an electrohydraulic partial brake system and an electromechanical partial brake system, which remains largely operational even without a mechanical fallback level in the event of electrical or electronic faults.

### SUMMARY

The disclosure presents a brake system for a motor vehicle, wherein the brake system includes an electrohydraulic partial brake system, an electromechanical partial brake system, a redundant power supply for the brake system, and an actuating device. The actuating device is configured to determine an actuating signal quantifying a brake request as a result of an actuation by a vehicle driver, wherein the brake system includes a brake control unit with at least two partitions which are independent of one another, and wherein the two partitions are each configured for controlling the electromechanical partial brake system and the electrohydraulic partial brake system on the basis of an actuating signal received from the actuating device.

An “electrohydraulic partial brake system” may be a brake system with hydraulically actuated wheel brakes, wherein a hydraulic pressure in the wheel brakes is generated by an electronic device. There is preferably no mechanical connection here between the brake actuating device and the wheel brakes or further components of the electrohydraulic partial brake system, with the result that a hydraulic pressure can be generated exclusively by the electronic device.

The “electromechanical partial brake system” may include an electromechanical force actuator and a wheel-specific control unit (wheel control unit WCU) for each wheel brake. Here, the wheel control unit is configured to actuate the force actuator on the basis of received signals for generating a brake force. The wheel control unit may be configured for this purpose at least to translate a received brake request into actuation signals of the force actuator. It can also be provided, furthermore, that the wheel control unit implements control procedures for closed loop controlling the generated brake force and for open loop controlling the force actuator. Here, the electromechanically actuated wheel brakes may include a parking brake function, by way of which the wheel brakes can be locked at a set brake force.

The “actuating device” may be an electric brake pedal. Such an electric brake pedal (also referred to as e-Pedal) usually has an actuating member for actuation by a vehicle driver, wherein a resetting device acts on the actuating member. The resetting device is configured to affect a restoring force acting in the direction of the rest position on the actuating member in the case of a displacement of the actuating member from its rest position. The force-displacement characteristic curve generated in this case is ideally designed such that the actuation of the actuating device for a vehicle driver feels the same as or similar to an actuation of a classic hydraulic brake system. The degree of actuation of the actuating member is detected by sensor, for example in the form of an actuation travel, an actuation angle and/or an acting actuation force, wherein an actuation signal is generated from the detected sensor variables. A brake system may then be actuated based on the actuation signal. The actuating device can be connected to the brake control unit, for example, via a SENT interface.

The “redundant power supply” may be designed in such a way that, in the event of a failure of one power supply, the other power supply ensures the reliable operation of the brake system as a whole. In one embodiment, one power supply can be a vehicle's on-board power supply. However, redundancy is not synonymous with the fact that all components of the brake system are still available in the event of a power supply failure. It can also be provided in fact that a failure of individual components is accepted if the failure of these components can be compensated by other components, or the failure has no significant effects on the operational readiness of the brake system.

A “partition” of a control unit may be a physical area of the control unit, which is electrically independent of further partitions of the control unit. In particular, the partitions of the control unit may be different areas of a printed circuit board or printed circuit boards which are separate from one another. The partitions are preferably connected to each other here via an internal data bus of the brake control unit, for example a CAN bus. The independence of the partitions is preferably such here that an electrical defect of one partition does not lead to a malfunction of the other partition.

The use of a brake control unit with independent partitions in conjunction with a redundant power supply and two differently acting partial brake systems has the advantage here that failures and in particular simple electrical faults do not lead to a severe degradation of the brake system. In particular, it can thus be avoided that an electrical fault in components that affect the electrohydraulic partial brake system already leads to a complete failure of the electrohydraulic partial brake system. In the ideal case, even in the event of a malfunction, a residual brake performance can thus always be maintained that meets the minimum requirements for a required brake performance (for example, a deceleration of at least 2.44 m/s²). In addition, such a brake system can also be used for automated driving functions, since a failure does not have to be compensated by the vehicle driver by means of a hydraulic intervention, but rather the brake system itself can in fact compensate for a partial failure.

According to one embodiment, the electrohydraulic partial brake system acts on a front axle of the motor vehicle, and wherein the electromechanical partial brake system acts on a rear axle of the motor vehicle. The electromechanical partial brake system may be configured in such a way that, even in the event of a total failure of the electrohydraulic brake system, a minimum deceleration of 2.44 m/s² can still be achieved by the wheel brakes of the rear axle of the vehicle.

In order to ensure redundant control of the electrohydraulic and the electromechanical partial brake system, it is further provided according to a further embodiment that the first and the second partition of the brake control unit each have a closed loop control microcontroller for carrying out brake open loop control and brake closed loop control functions on the basis of an actuating signal received from the actuating device. The closed loop control microcontroller may be configured to carry out closed loop control functions for the targeted control of the brake forces generated in the respective wheel brakes based on received actuation information and taking into account further information, in particular wheel speeds, accelerations acting on the vehicle or changes in the yaw angle or the pitch angle of the vehicle. Information generated in this process regarding brake forces to be set can then be passed on to the corresponding partial brake systems as control information. The redundant provision of two such closed loop control microcontrollers has the advantage that, even if one of the partitions of the brake control unit fails, targeted closed loop control of the generated brake forces in the wheel brakes remains possible. To this end, the two closed loop control microcontrollers may be supplied with the same or with equivalent input signals.

According to one embodiment, it is further provided that the electrohydraulic partial brake system has an electric motor-driven pressure provision device for generating a hydraulic brake pressure in hydraulic wheel brakes assigned to the electrohydraulic partial brake system, wherein the pressure provision device can be disconnected hydraulically from the hydraulic wheel brakes by a first pressure sequence valve arranged between the pressure provision device and the wheel brakes.

The electric motor-driven pressure provision device can be in particular a so-called linear actuator, in which an electric motor with a downstream rotational/translational gear mechanism is configured to move a pressure piston within a hydraulic cylinder. In particular, the rotational/translational gear mechanism can be a ball screw drive. The electric motor can be a brushless motor, in particular. The pressure sequence valve arranged between the pressure provision device and the wheel brakes may be configured here such that it is normally closed. Furthermore, in this embodiment, the pressure sequence valve opens at a sufficiently high hydraulic pressure generated by the pressure provision device. This configuration makes it possible, firstly, to specifically decouple the pressure provision device from the wheel brakes, with the result that, for example, in the case of ABS closed loop control by the pressure provision device, brake fluid can be replenished from a reservoir without reducing the brake pressure in the wheel brakes.

In order to achieve a redundancy of the actuation of the electrohydraulic partial brake system in this design of the electrohydraulic partial brake system, it is provided according to one embodiment that both partitions of the brake control unit are configured to actuate the electric motor-driven pressure provision device on the basis of an item of actuation information. For this purpose, both partitions may be connected to a controller of the power electronics of the electric motor. In this way, even if one of the partitions fails, it is still possible to precisely control the hydraulic pressure in the electrohydraulic partial brake system.

According to a further embodiment, it is provided here that only the first partition of the brake control unit is configured to actuate the first pressure sequence valve. A targeted pressure actuation in the hydraulically operated wheel brakes can also still be achieved by the second partition in this case, if the pressure sequence valve opens at a sufficiently high pressure from the side of the pressure provision device. Since the pressure sequence valve is normally closed, it would also still be possible to replenish brake fluid by way of the pressure provision device.

In order to be able to still precisely establish a hydraulic connection between the pressure provision device and the hydraulically actuated wheel brakes even in the event of a failure of the first partition, it is provided according to a further embodiment that a second pressure sequence valve is arranged between the pressure provision device and the wheel brakes, wherein the second pressure sequence valve is arranged hydraulically parallel to the first pressure sequence valve, and wherein only the second partition is configured to actuate the second pressure sequence valve. In this way, a significantly more harmonious behavior of the electrohydraulic brake system can be achieved in the event of failure of the first partition, since the corresponding hydraulic pressure would already be transferred to the hydraulically actuated wheel brakes at small hydraulic pressures generated by the pressure provision device.

According to a further embodiment, it is provided, furthermore, that the electric motor-driven pressure provision device is assigned a motor position sensor for determining an operating parameter of the electric motor, and the hydraulic partial brake system has a pressure sensor for determining the hydraulic pressure prevailing in the hydraulic partial brake system, wherein the motor position sensor is connected to the first partition of the brake control unit, and wherein the pressure sensor is connected to the second partition of the brake control unit.

It is provided here that in normal operation of the brake system, that is, in the case of full functionality of the partition, the open loop control of the electric motor pressure provision device is carried out on the basis of the signal of the motor position sensor, while the closed loop control of the hydraulic pressure in the closed loop control circuit is carried out on the basis of the signal of the pressure sensor. In the event of failure of the first partition, it can then be provided that the closed loop control of the electric motor pressure provision device is carried out by the second partition without motor position signal on the basis of the measured hydraulic pressure. Methods for controlling brushless motors without motor position signal are known and use, for example, an actuation concept in which in each case one of the three phases of the electric motor is used cyclically alternately as a sensor replacement. The closed loop control of the hydraulic pressure continues in a closed loop control circuit based on the pressure sensor signal.

A safe and reliable self-release behavior of the hydraulically actuated wheel brakes is achieved according to a further embodiment in that the hydraulic partial brake system has a brake fluid reservoir, wherein two series-connected normally open shut-off valves are arranged between the brake fluid reservoir and the hydraulic wheel brakes, wherein the shut-off valves are configured to controllably interrupt or establish a hydraulic connection between the wheel brakes and the brake fluid reservoir, wherein the first partition of the brake control unit is configured to actuate a first of the shut-off valves, and the second partition of the brake control unit is configured to actuate a second of the shut-off valves. The brake fluid reservoir is preferably configured here such that atmospheric pressure prevails within the brake fluid reservoir.

This ensures that in the event of a failure of both partitions, i.e., a total failure of the electrohydraulic brake system, the wheel brakes are connected to atmospheric pressure, with the result that the wheel brakes can be easily released and no residual braking torque which destabilizes the vehicle is generated by the wheel brakes. In normal operation of the brake system, i.e. when the first and second partition are fully functional, both shut-off valves are preferably closed, with the result that a pressure generated by the pressure provision device can be applied fully in the wheel brakes. The redundant design of the shut-off valves here ensures that even if one of the partitions fails, operation of the electrohydraulic partial brake system by means of the electric motor pressure provision device still remains possible by hydraulically separating the wheel brakes on the inlet side from the brake fluid reservoir.

According to a further embodiment, it is provided, furthermore, that the hydraulic wheel brakes are each assigned wheel pressure modulation valves for wheel-individual modulation of a hydraulic pressure provided by the pressure provision device, wherein the second partition of the brake control unit is configured to actuate the wheel pressure modulation valves. The wheel pressure modulation valves may include at least one inlet valve and one outlet valve per wheel brake here. The valves can be in particular analogized solenoid valves, which enable a very fine regulation of the applied pressure in the wheel brakes. The inlet valves of the wheel brakes are each of preferably normally open design, while the outlet valves of the wheel brakes are each normally closed. Thus, even in the event of failure of the second partition and thus missing control of the wheel pressure modulation valves, a hydraulic pressure in the wheel brakes can continue to be generated by the electric motor pressure provision device.

The first and second partitions of the brake control unit, as previously described, preferably have independent microcontrollers, which are configured for implementing certain functions. In this case, the overall structure of the brake control unit according to one embodiment can be simplified in that the brake control device has an open loop control microcontroller, wherein the open loop control microcontroller is configured for actuating the components of the electrohydraulic partial brake system, in particular for actuating the pressure provision device and the hydraulic valves of the electrohydraulic partial brake system, and wherein the first and the second partition are each configured to access the open loop control microcontroller for actuating the elements, assigned to the respective partitions, of the electrohydraulic partial brake system. Such a design is based here on the consideration of how probable a failure of such an open loop control microcontroller is, and whether, in view of the probability, such a failure is more likely to outweigh the increased complexity of the brake control unit with two independent open loop control microcontrollers. In this case, the open loop control microcontroller would be neither part of the first partition nor part of the second partition. The open loop control microcontroller may in particular consist here of a motor control microcontroller for actuating the electric motor of the electric motor pressure provision device and a valve control microcontroller for actuating the valves of the electrohydraulic partial brake system, wherein the respective closed loop control microcontroller of the partitions can access the motor control microcontroller and the valve control microcontroller for implementing the respective assigned functionalities.

In one alternative embodiment to this, it is provided that the brake control unit has a motor control microcontroller for actuating the electric motor of the electric motor-driven pressure provision device, and the partitions each have a valve control microcontroller for actuating the valves of the electrohydraulic partial brake system, and wherein the first and the second partition are each configured to access the motor control microcontroller for actuating the electric motor of the electric motor-driven pressure provision device. In this case, accordingly, only the control of the electric motor pressure provision device would not be of redundant configuration, wherein both partitions can each access the corresponding motor control microcontroller.

Both embodiments described above are based on the core concept of providing a required redundancy in the control of the brake system with as little component complexity as possible and in doing so only configuring each function module or microcontroller twice, which as expected have a high failure rate.

According to a further embodiment, it is further provided that the actuating device has at least two sensor devices for detecting an actuation of the actuating device, wherein a first of the sensor devices is directly connected to the first partition of the brake control unit, and wherein a second of the sensor devices is directly connected to the second partition of the brake control unit. In this way, it is ensured that, firstly, each of the partitions can separately carry out an open loop control and closed loop control of the generated brake forces, while at the same time ensuring that in the event of failure of one of the sensor devices of the actuating device, reliable detection and processing of an actuation by the vehicle driver is still ensured. The sensor devices are each preferably connected here to the closed loop control microcontroller of the respective partition.

The electrohydraulic partial brake system can be of particularly compact configuration here and the signal paths can be kept very short if, according to one embodiment, the brake control unit is formed as part of the electrohydraulic partial brake system. In this case, the valves and the electric motor pressure provision device of the electrohydraulic partial brake system are preferably arranged in a common valve block or a hydraulic control unit, wherein the hydraulic control unit can also be equipped with a brake fluid reservoir. The brake control unit in the form of the corresponding printed circuit boards can then be arranged directly on the hydraulic control unit, resulting in a very compact overall package. In order to manufacture the entire brake system, such an arrangement must only be hydraulically connected to the hydraulic wheel brakes and electrically connected to the electromechanical wheel brakes, the on-board power supply and the actuating device.

For the transmission of control information from the partitions of the brake control unit to the electromechanical wheel brakes, it is provided in a further embodiment that the first and the second partition of the brake control unit are each connected to the electromechanical partial brake system via a data bus, for example a CAN bus. Both partitions can thus likewise transmit information via the data bus to control the electromechanical partial brake system.

According to a further embodiment, it is provided, furthermore, that the first and second partitions of the brake control unit are each connected via a communications interface to further control units of the motor vehicle. In this way, for example, control information can be received from automated driving functions, such as, for example, from an autopilot. In addition, further information regarding the driving position of the vehicle, in particular in the form of information regarding the yaw angle or pitch angle of the vehicle, can thus be taken into account in the closed loop control of the brake forces.

The redundancy of the actuation of the brake system is improved here according to a further embodiment in that the first partition and the second partition of the brake control unit are connected to each other via a data connection. Thus, for example, actuation signals received by the actuating device can be exchanged between the partitions, in particular when one of the sensor devices of the actuating device has failed. Furthermore, a plausibility of the received actuation signals, as well as of further signals, present in the respective partitions, of the brake system can be monitored in this manner as well.

In order to provide a redundant power supply, it is provided according to a further embodiment that the brake system has two independent power sources as the power supply, one of which supplies the first partition of the brake control unit and a first of the electromechanical wheel brakes with power, and a second of which supplies the second partition of the brake control unit and a second of the electromechanical wheel brakes with power. As has already been stated, the power supplies are, for example, separate on-board power supplies of the vehicle. In this variant, even if one of the two power supplies fails, at least one partition of the brake control unit and thus the electrohydraulic partial brake system and an electromechanical wheel brake of the electromechanical partial brake system remain available. In the case of a division in which the electrohydraulic partial brake system acts on the front axle of the vehicle while the electromechanical partial brake system acts on the rear axle of the vehicle, it is therefore still possible to brake the vehicle with both front wheel brakes and a rear wheel brake even if one of the power supplies fails. Any possibly present parking brake function of the electromechanical wheel brakes is also retained for at least one wheel brake.

This variant is accordingly characterized by a high availability of the normal brake function as well as the parking brake function. It is preferably to be ensured that faults in the brake control unit and in particular in the partition, which is assigned to the electrohydraulic partial brake system, cannot lead to a failure in the power supply. To this end, for example, thermal fuses and seals can be provided between the partitions. Furthermore, cutting disks, which can disconnect the brake control unit from the respective power supply in the event of a fault, can be provided outside the brake control unit.

In one alternative refinement to this, it is provided according to a further embodiment that the brake system has two independent power sources, in particular on-board power supplies of the motor vehicle, as power supply and is connected to a second control unit, wherein a first of the power sources supplies the first and second partition of the brake control unit with power, and a second of the power sources supplies the electromechanical wheel brakes and the second control unit with power, wherein the second control unit is connected to the brake actuating unit and to the electromechanical and the electrohydraulic brake system for data transmission. In such a configuration, it is no longer necessary to completely decouple the partitions, since both partitions are powered by the same power supply. In this case, in the event of a failure of the first power supply, the electrohydraulic partial brake system would no longer be available, but it would still be possible to decelerate the vehicle by means of the electromechanical partial brake system.

The detection of a driver's brake request in the form of an actuating signal is further possible here by way of the connection between the second control unit and the brake actuation unit, wherein the second control unit can actuate the wheel brakes of the electromechanical partial brake system in accordance with the implementation of the brake request. The second control unit may be configured in particular in the form of a zone computer, that is, a control unit which is not necessarily only assigned to the braking function of the vehicle, but also, for example, assumes further functions of the vehicle controller. Furthermore, the second control unit may also be a wheel control unit (WCU) of one of the electromechanical wheel brakes.

In this case, according to a further embodiment, it is further provided that the second power source is additionally configured to supply the first and second partition of the brake control unit with power, wherein a switching device is provided, wherein the switching device is configured to switch over the power supply of the first and second partition of the brake control unit between the first and second power source.

This can thus ensure that only one of the two power sources supplies power to the partitions and the electrohydraulic partial brake system at any time. If one of the two power sources fails, the system automatically switches over to the respective other power source, with the result that no electrical effects can occur on the failed or still intact power source. It may further be provided that one of the electromechanical wheel brakes is supplied with power by the first power source and the other electric wheel brake is supplied with power by the second power source, such that even in the event of failure of one of the power sources, the parking function implemented in the electromechanical wheel brakes is still maintained.

In a further aspect, the disclosure provides an electrohydraulic brake device for a brake system, as has been previously described. In particular, the electrohydraulic brake device here may comprise the brake control unit, the electric motor-driven pressure provision device, and the described valves of the electrohydraulic partial brake system.

### BRIEF DESCRIPTION OF THE DRAWINGS

In the following, embodiments of the disclosure will be explained in more detail with reference to the drawings, in which:

FIG. 1 shows a schematic representation of a first exemplary brake system,

FIG. 2 shows a schematic representation of a second exemplary brake system,

FIG. 3 shows a schematic representation of a third exemplary brake system,

FIG. 4 shows a schematic representation of a fourth exemplary brake system,

FIG. 5 shows a hydraulic circuit diagram of an exemplary electrohydraulic partial brake system,

FIG. 6 shows a hydraulic circuit diagram of an electrohydraulic partial brake system modified with respect to FIG. 5,

FIG. 7 shows a schematic representation of a first exemplary electrical concept of a brake system,

FIG. 8 shows a schematic representation of a second exemplary electrical concept of a brake system, and

FIG. 9 shows a schematic representation of a third exemplary electrical concept of a brake system.

### DETAILED DESCRIPTION

Features that are similar or identical to each other are denoted below by the same reference numerals.

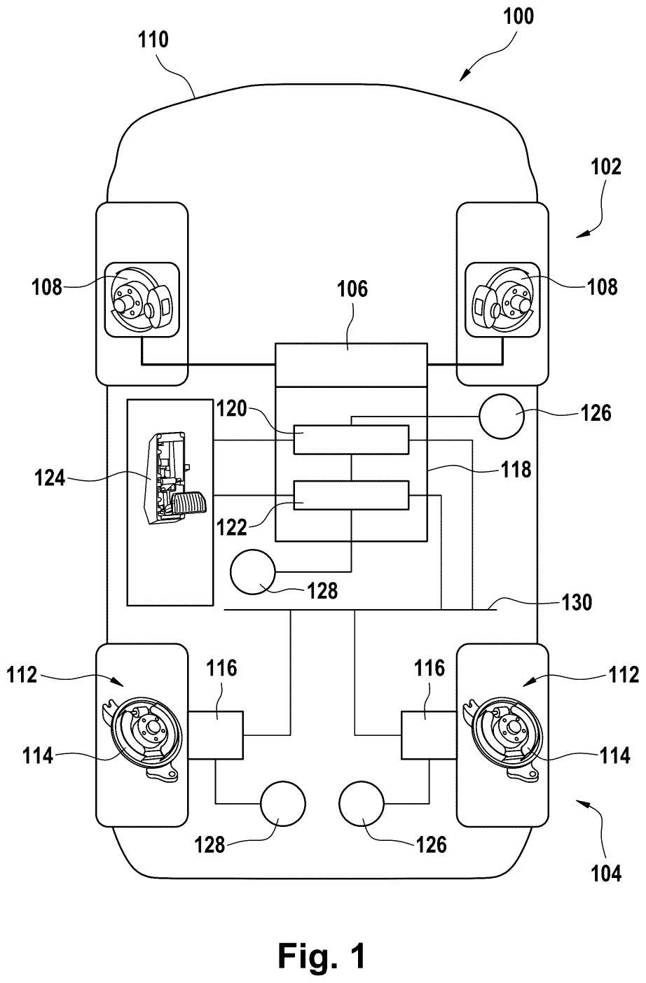

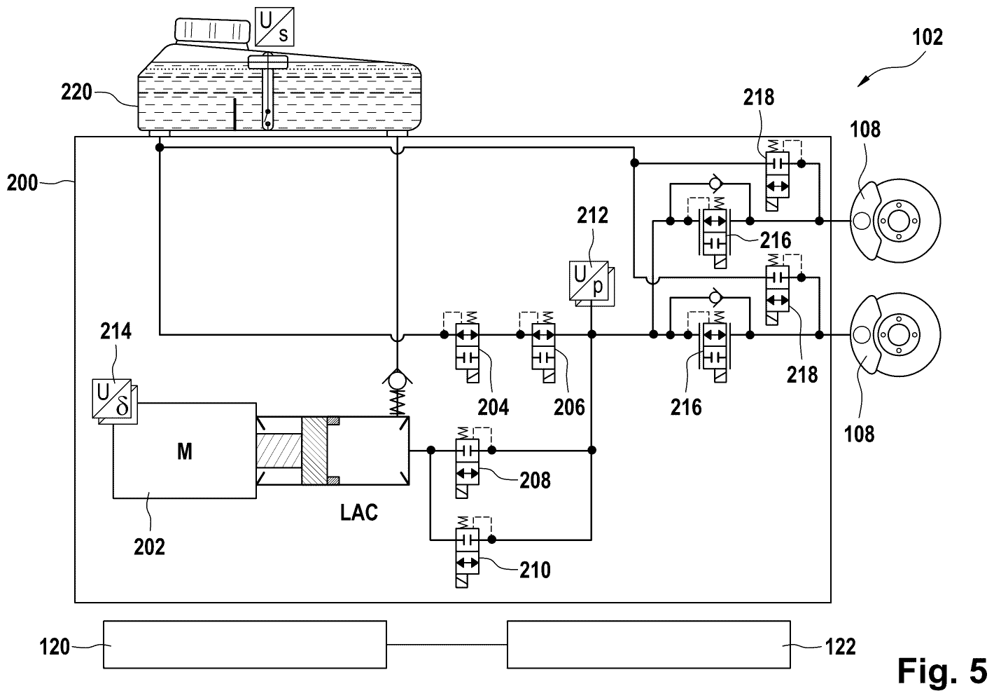

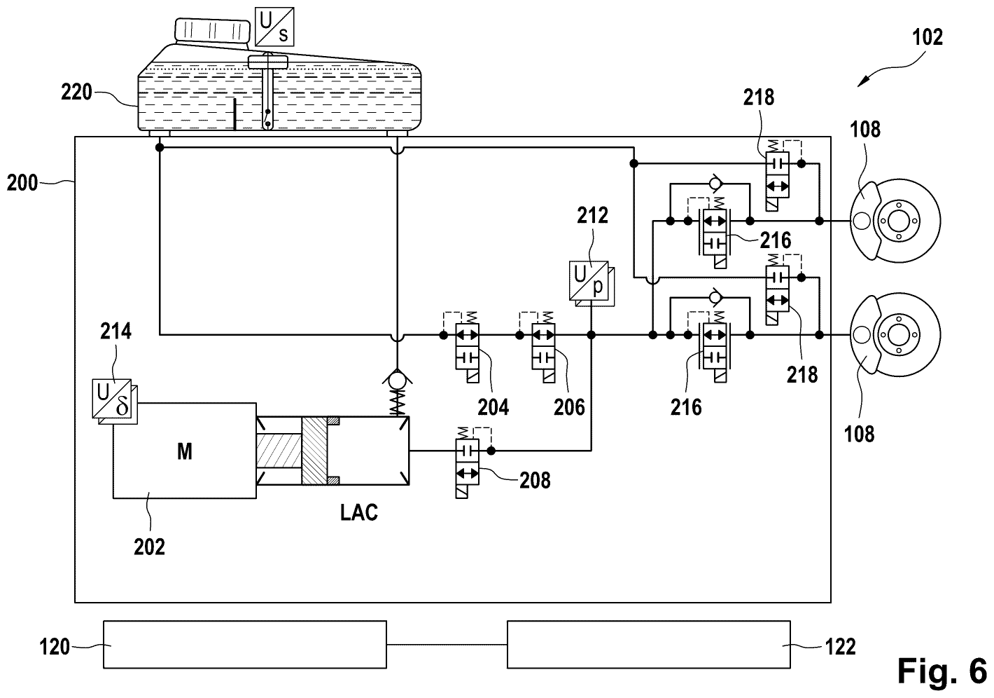

FIG. 1 shows a schematic representation of a first exemplary brake system 100, wherein the brake system 100 has an electrohydraulic partial brake system 102 and an electromechanical partial brake system 104. The electrohydraulic partial brake system 102 is composed here of a hydraulic control unit 106 and two hydraulically actuated wheel brakes 108, wherein the hydraulically actuated wheel brakes 108 are assigned to the front axle of the illustrated motor vehicle 110. The specific structure of the hydraulic control unit 106, which is configured to provide a hydraulic pressure for the wheel brakes 108, is also discussed below with reference to FIGS. 5 and 6.

The electromechanical partial brake system 104 has electromechanically actuated wheel brakes 112 assigned to the rear wheels of the motor vehicle 110, wherein the electromechanically actuated wheel brakes 112 each have a force actuator 114 and a wheel control unit (WCU) 116. The wheel control units 116 are configured to actuate the force actuators 114 for generating a brake force on the basis of a control signal.

The brake system 100 further includes a brake control unit 118, wherein the brake control unit 118 is shown in FIG. 1 as part of the electrohydraulic partial brake system 104. The brake control unit 118 has a control logic circuit here for controlling the entire brake system 100 and is divided into two partitions 120 and 122. The partitions may, for example, be different and independent areas of a printed circuit board or separate printed circuit boards within the brake control unit 118. Furthermore, the brake system 100 has an actuating device 124, wherein the actuating device 124 is configured in the form of an electric pedal (e-Pedal). Accordingly, there is no direct mechanical or hydraulic connection between the actuating device 124 and the wheel brakes 108, with the result that a direct actuation of the wheel brakes 108 by means of the actuating device 124 is not possible.

Finally, the brake system 100 has a redundant power supply, whereby the power supply is provided by two independent power sources 126 and 128 in the form of independent on-board power supplies. In this case, a first of the partitions 120 and one of the electromechanical wheel brakes 112 is supplied with power by a first of the power sources 126, while a second of the partitions 122 and the respective other electromechanical wheel brake 112 is supplied with power by a second of the power sources 128.

The actuating device 124 may include two sensor devices for determining actuation signals or for detecting an actuation degree of the actuating device 124 in the illustrated embodiment. These can be, for example, displacement sensors, angle sensors or force sensors. In this case, a first of these sensors is directly connected to the first partition 120 and a second of these sensors is directly connected to the second partition 122, for example via a SENT interface, with the result that corresponding actuation signals are transmitted redundantly to both partitions 120 and 122.

The partitions 120 and 122 are connected to each other here via a data bus, in particular a CAN bus, with the result that, for example, the received actuation signals can be exchanged between the partitions 120 and 122. Furthermore, the brake system includes a data bus 130, in particular a CAN bus, wherein the first partition 120, the second partition 122 and the wheel control units 116 are connected to each other via the data bus 130.

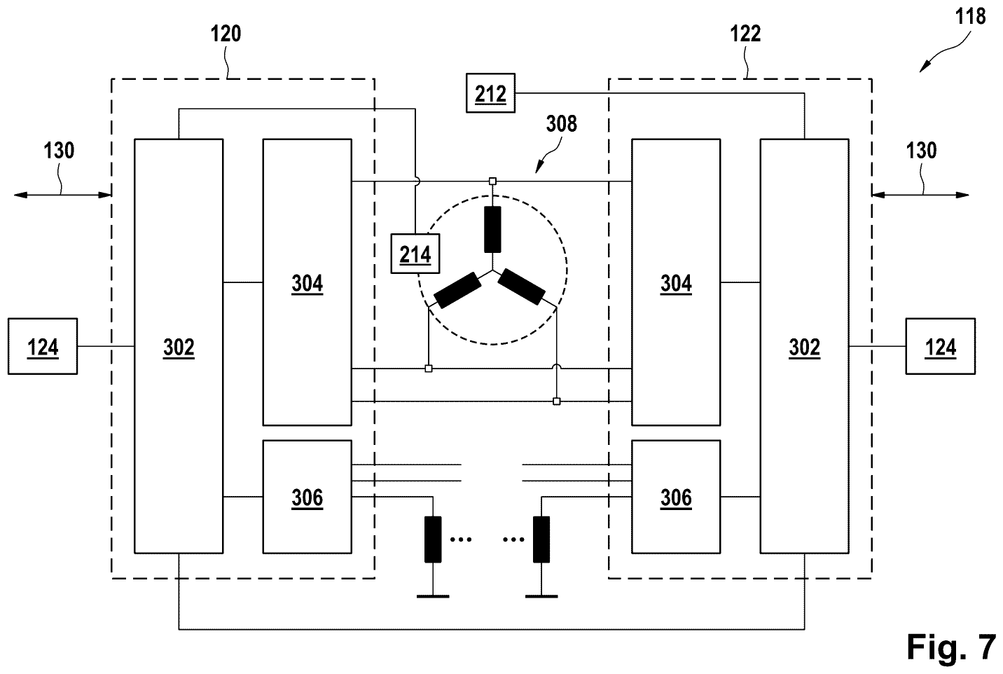

In the configuration of the brake system 100 shown here, it is ensured that even in the event of failure of one of the power sources 126 or 128, one of the partitions 120 or 122 is still available in each case, with the result that the electrohydraulic partial brake system 102 and one of the electromechanical wheel brakes 112 can still be used for decelerating the motor vehicle 100. Consequently, the motor vehicle 100 can still be decelerated with both front axle brakes and with one rear axle brake. In so far as a parking brake function is also implemented in the electromechanical wheel brakes 112, the parking brake function of at least one rear wheel of the motor vehicle 110 remains even in the event of failure of one of the power sources 126 or 128. The electronic implementation of the redundancy of the actuation of the electrohydraulic partial brake system 102 by the partitions 120 and 122 is described below with reference to FIGS. 7 to 9.

The configuration of the brake system 100 shown in FIG. 1 therefore leads to a high availability of both the normal braking function and the parking brake function. In this case, it is preferably ensured that a failure in one of the partitions 120 or 122 cannot result in a failure of both power sources 126 or 128. For this purpose, for example, a thermal fuse and seal may be provided between the partitions 120 and 122. Furthermore, the use of circuit breakers, which decouple the brake control unit 118 from the power sources 126 or 128 in the event of a fault, may also be provided here.

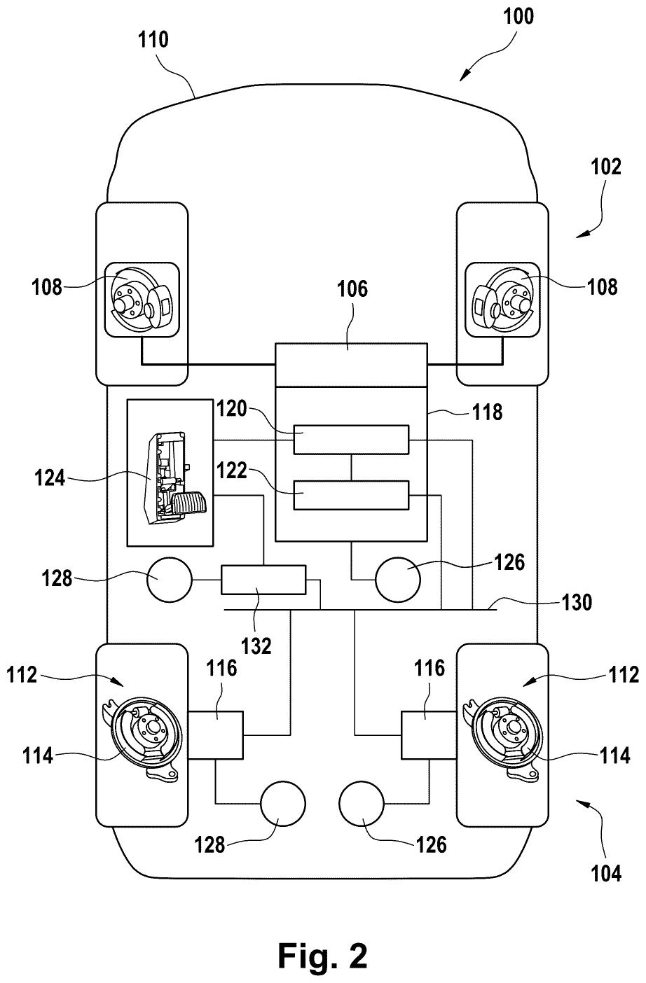

FIG. 2 shows a schematic representation of a second exemplary brake system 100 that differs in the basic structure of the brake system 100 essentially only with regard to the connection of the individual components of the brake system 100 to the power sources 126 and 128. Furthermore, an additional second control unit 132 is provided in the brake system 100 of FIG. 2. In this case, it is provided in the illustrated variant of the brake system 100 that the brake control unit 118 and thus both partitions 120 and 122 are supplied with power exclusively by the first power source 126. Thus, in this embodiment, it is also not absolutely necessary to decouple the partitions 120 and 122 from each other, since an influence on the second power source 128 by an electrical fault in the brake control unit 118 is excluded. Furthermore, both electromechanical wheel brakes 112 of the electromechanical partial brake system 104 are supplied with power by the second power source 128. In addition, the partitions 120 and 122 are connected only to one of the sensors of the actuating device 124.

Consequently, in this scenario, in the event of a failure of the first power source 126, the vehicle can be decelerated only via the electromechanical wheel brakes 112 of the electromechanical partial brake system 104. In order to be able to still reliably detect the driver's brake request in such a failure scenario and to be able to continue to supply the wheel control units 116 of the electromechanical wheel brakes 112 with appropriate control information, one of the sensors of the actuating device 124 is connected to the second control unit 132. The second control unit 132 is supplied with power here by the second power source 128 and is connected to the data bus 130. Consequently, in the event of failure of the electrohydraulic partial brake system 102 as a result of a malfunction of the first power source 126, a driver's brake request by the second control unit 132 can still be processed and transmitted to the electromechanical wheel brakes 112 or the wheel control units 116, wherein the wheel control units 116 are then configured to actuate the wheel brakes 112 or force actuators 114 in accordance with the implementation of the driver's brake request.

The second control unit 132 may be configured in particular as a zone computer. In this case, a zone computer is to be understood as a control unit which implements not only functions of the brake system but also further driving functions or control functions of the motor vehicle 110. Alternatively, it may be provided that one of the wheel control units 116 takes over the function of the second control unit 132 and consequently is also directly connected to one of the sensors of the actuating device 124. If the second power source 128 fails in the configuration shown, both electromechanical wheel brakes 112 can no longer be actuated, with the result that a parking brake function is possibly also no longer available.

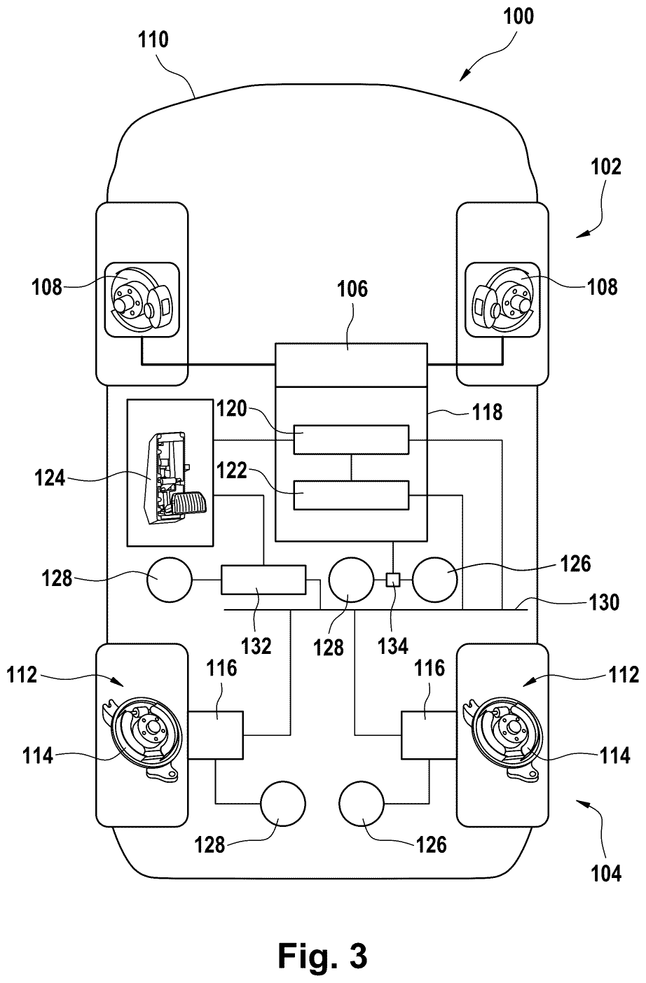

FIG. 3 shows a further schematic representation of a third exemplary brake system 100, wherein the brake system shown in FIG. 3 differs from the variant of FIG. 2 in that the brake control unit 118 and thus the electrohydraulic partial brake system 102 are connected to the first power source 126 and the second power source 128, wherein a switching device 134 is arranged between the brake control unit 118 and the power sources 126 and 128. The switching device 134 ensures that only one of the sources 126 or 128 supplies the brake control unit 118 with power at any time. It is further provided that in the event of failure of one of the power sources 126 or 128, the switching device 134 switches over to the other power source. As a result, faults within the electrohydraulic partial brake system 102 and within the brake control unit 118 cannot affect both power sources 126 and 128.

Furthermore, in the configuration of FIG. 3, one of the electromechanical wheel brakes 112 is supplied with power from the first power source 126, while the respective other electromechanical wheel brake 112 is supplied with power from the second power source 128. Consequently, in this configuration, if one of the power sources 126 or 128 fails, the parking brake function of one of the electromechanical wheel brakes 112 will still be available.

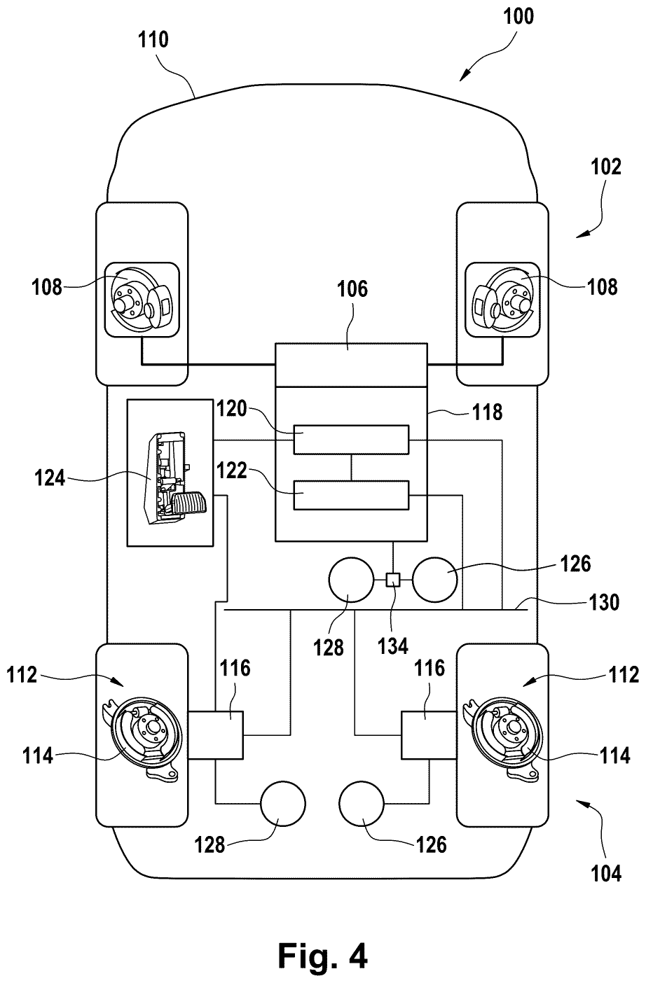

The schematic representation of a fourth exemplary brake system 100 shown in FIG. 4 shows essentially the configuration of FIG. 3, wherein one of the wheel control units 116 assumes the function of the second control unit 132 here, with the result that the second control unit 132 is not taken into account in the brake system 100 shown here. Accordingly, in this case, the wheel control unit 116 of the rear left electromechanical wheel brake 112 is directly connected to the actuating device 124.

FIG. 5 now shows a hydraulic circuit diagram of an exemplary electrohydraulic partial brake system 102. The electrohydraulic partial brake system 102 has a hydraulic block 200 here, wherein an electric motor pressure provision device 202 with a motor position sensor 214, two shut-off valves 204 and 206 connected in series, two pressure sequence valves 208 and 210 connected in parallel, a pressure sensor 212 and an inlet valve 216 and an outlet valve 218 for each wheel brake are arranged in the hydraulic block 200. Furthermore, the hydraulic pressure 200 is connected to a brake fluid reservoir 220 and the hydraulically operated wheel brakes 108. Furthermore, the partitions 120 and 122 of the brake control unit 118 are shown in FIG. 5. The electric motor pressure provision device 202 is preferably driven here by a brushless electric motor, the actuation of which can be carried out by both partitions 120 and 122 of the brake control unit 118.

The electric motor pressure provision device 202 is hydraulically connected to the wheel brakes 108, wherein the parallel-connected pressure sequence valves 208 and 210 are arranged between the wheel brakes 108 of the electric motor pressure provision device 202. The pressure sequence valves 208 and 210 are formed as normally closed valves, wherein the pressure sequence valves 208 and 210 are preferably configured such that at a sufficiently high pressure generated by the pressure provision device 202, the pressure sequence valves 208 and 210 open. In addition, the pressure sensor 212 and a normally open inlet valve 216 per wheel brake 108 are arranged between the pressure sequence valves 208 and 210 and the wheel brakes 108. The inlet valves 216 are preferably formed here as analogized solenoid valves for modulating a pressure generated by the pressure provision device 202.

The wheel brakes 108 are in turn connected to the brake fluid reservoir 220 via the outlet valves 218, wherein the outlet valves 218 are formed as normally closed valves. Finally, the wheel brakes 108 are connected on the inlet side to the brake fluid reservoir 220, wherein two shut-off valves 204 and 206 connected in series are arranged between the brake fluid reservoir 220 and the wheel brakes 108. The shut-off valves 204 and 206 are configured here as normally open valves, so that in the event of a failure of the power supply of the brake system 100, the wheel brakes 108 are hydraulically connected to the brake fluid reservoir 220. In this way, due to the atmospheric pressure prevailing in the brake fluid reservoir 220, a possibly applied brake pressure in the wheel brakes 108 can be dissipated, with the result that in the event of a fault, no residual braking torque is generated by the wheel brakes 108.

The partitions 120 and 122 are each configured here to actuate different elements of the electrohydraulic partial brake system 102. The first partition 120 is configured here to actuate a first of the shut-off valves 204 and a first of the pressure sequence valves 210 and to actuate the pressure provision device 202, while the second partition 122 is configured to actuate a second of the shut-off valves 206 and a second of the pressure sequence valves 210 and to control the inlet valves 216 and the outlet valves 218. Furthermore, the second partition 122 is preferably also configured to actuate the pressure provision device 202. This is explained in more detail below.

In normal operation of the electrohydraulic partial brake system 102 shown, the two shut-off valves 204 and 206 are closed, while the pressure sequence valves 208 and 210 are open, with the result that a direct hydraulic connection is established between the pressure provision device 202 and the wheel brakes 108. The hydraulic pressure then provided by the pressure provision device 202 on the basis of an actuating signal can then be individually modulated in each case by the inlet valves 216 and the outlet valves 218 for the wheel brakes 108, whereby in particular ABS closed loop control functions can be implemented. The control of the pressure provision device 202 is preferably based here on a signal of the motor position sensor 214, while the closed loop control of the pressure in the electrohydraulic partial brake system 102 is carried out on the basis of a pressure determined by the pressure sensor 212.

If, for example, as a result of ABS closed loop control, the pressure provision device 202 has utilized its maximum stroke, with the result that no further hydraulic pressure can be generated by the pressure provision device 202, it is provided in this case that the pressure sequence valves 208 and 210 are closed, with the result that the pressure provision device 202 can replenish hydraulic fluid from the brake fluid reservoir 220 by retracting the pressure piston without changing the pressures present in the wheel brakes 108 in the process.

In the event of a failure of one of the partitions 120 or 122, in the hydraulic configuration shown, the connection between the brake fluid reservoir 220 and the wheel brakes 108 can always still be interrupted by the respective other partition by means of the respective shut-off valve 204 or 206, with the result that a pressure generated by the pressure provision device 202 is supplied to the wheel brakes 108. In addition, in the event of failure of one of the partitions 120 or 122, the hydraulic connection between the pressure provision device 202 and the wheel brakes 108 can also still be specifically established or interrupted by a corresponding actuation of the pressure sequence valves 208 and 210. It is no longer possible to use the electrohydraulic partial brake system 102 only after both partitions 120 and 122 fail. In this case, however, both shut-off valves 204 and 206 are open, with the result that the brake pressure applied in the wheel brakes 108 is equalized to atmospheric level and no residual braking torque remains.

FIG. 6 shows a hydraulic circuit diagram of a system which is only slightly modified compared to the electrohydraulic partial brake system 102 described previously with reference to FIG. 5. In this case, the second pressure sequence valve 210, which is controlled by the second partition 122, is omitted only in FIG. 6. In this case, the first pressure sequence valve 208, which is controlled by the first partition 120, is preferably configured such that at a sufficiently high pressure generated by the pressure provision device 202, the pressure sequence valve 208 opens, with the result that the generated pressure is available in the wheel brakes 108. Accordingly, in this configuration, even in the event of a failure of the first partition 120, an actuation of the wheel brakes 108 by the pressure provision device 202 can still be carried out. In this case, a pressure dissipation from the wheel brakes 108 can only take place via the outlet valves 218 and no longer via the pressure provision device 202. To this end, the outlet valves 218 can be actuated by the second partition 122 by means of appropriately dimensioned pulses such that they open briefly in order to specifically reduce the pressure applied in the wheel brakes 108.

FIG. 7 shows a schematic representation of a first exemplary electrical concept of a brake control unit 118 of a brake system 100, as has previously been described. To this end, FIG. 7 schematically shows the first partition 120 and the second partition 122, wherein the partitions 120 and 122 each have function modules in the form of microcontrollers. The partitions 120 and 122 are each connected to the data bus 130 or a communication interface here, and are each connected to a sensor device of the actuating device 124, with the result that both partitions 120 and 122 can independently implement a driver's brake request, as well as receive the brake request of an automated driving system. Furthermore, a status message of the brake system 100 can also be transmitted to further control units of the motor vehicle via the communication interface.

The two partitions 120 and 122 each have three function modules, wherein a first function module 302 is configured as a closed loop control microcontroller, a second function module 304 is configured as a motor control microcontroller and a third function module 306 is configured as a valve control microcontroller. In this case, the actuating signals of the actuating device 124 are first supplied to the closed loop control microcontroller 302, wherein the closed loop control microcontroller 302 is configured to perform brake closed loop control functions, such as ABS control. To this end, the closed loop control microcontroller can also draw on further signals of the motor vehicle 110, in particular wheel speeds and acceleration values, which are received, for example, via the data bus 130. Based on the received signals, the closed loop control microcontroller 302 transmits corresponding control information to the motor control microcontroller 304 and the valve control microcontroller 306.

Furthermore, the closed loop control microcontroller 302 of the first partition 120 is connected to the closed loop control microcontroller 302 of the second partition 122, with the result that corresponding control information and in particular the received actuation information can also be exchanged between the partitions 120 and 122. Consequently, in normal operation, the control of the brake system 100 can be carried out on the basis of both actuation signals, while in the event of failure of one of the partitions 120 or 122, the driver's brake request in the form of the corresponding actuation signal in the still active partition can be further processed. Furthermore, the closed loop control microcontroller 302 is configured to determine control information for the wheel control units 116 of the electromechanical wheel brakes 112 and to transmit it via the data bus 130 to the wheel control units 116.

The motor control microcontrollers 304 of both partitions 120 and 122 are configured in principle here for controlling the electric motor 308 of the electric motor pressure provision device 202, while the valve control microcontrollers 306 in the partitions 120 and 122 are each configured to actuate the valves of the electrohydraulic partial brake system 102 which are assigned to the partitions 120 and 122.

To this end, it is provided that the motor position sensor 214 is connected to the first partition 120, while the hydraulic pressure sensor 212 is connected to the second partition 122. In normal operation, i.e. as long as both partitions 120 and 122 are fully functional, the closed loop control of the electric motor 308 is carried out with the signal of the motor position sensor 214, while the closed loop control of the hydraulic pressure in the electrohydraulic partial brake system 102 is carried out in a closed circuit with the signal of the pressure sensor 212.

In the event of failure of the first partition 120, in contrast, the closed loop control of the electric motor 308 in the second partition 122 can still be carried out without the signal of the motor position sensor 214. To this end, for example, an actuation concept can be used in which one of the three phases of the electric motor 308 is used cyclically alternately as a sensor replacement. With this closed loop control type, the dynamic response and maximum torque of the electric motor 308 can be limited. However, this is acceptable for operation on a fallback level, i.e. in the presence of partial malfunctioning of the brake system 100. In this case, the control of the hydraulic pressure preferably continues in a closed loop with the signal of the pressure sensor 212.

If the second partition 122 fails, the hydraulic pressure can no longer be set in the closed control loop because the signal of the pressure sensor 212 is no longer available. Instead, in this case, the necessary volume displacement can be calculated on the basis of a known pressure-volume characteristic curve of the hydraulic front wheel brakes 108, and this can be realized with the aid of the signal of the motor position sensor 214.

The redundancy of the electrohydraulic partial brake system 102 shown and described can be provided in various degrees here. In the variant shown in FIG. 7, in which the failure of one of the partitions 120 or 122 can be almost completely compensated by the respective other partition, it is provided to this end that all function modules are completely contained in each partition 120 and 122. However, such a configuration can also be detrimental depending on the design of the electric motor 308 and its actuation, in particular when designing the electric motor 308 as a brushless motor with a three-phase winding system, wherein both motor control microcontrollers 304 are connected to the same winding system. In this case, for example, it is possible that an electrical fault, in particular a short circuit, in one of the motor control microcontrollers 304, due to the common connection to the winding system of the electric motor 308, influences the respective other motor control microcontroller 304. However, such faults are to be considered unlikely. However, in the case of such a fault, the motor vehicle 110 could still be decelerated by the electromechanical partial brake system 104.

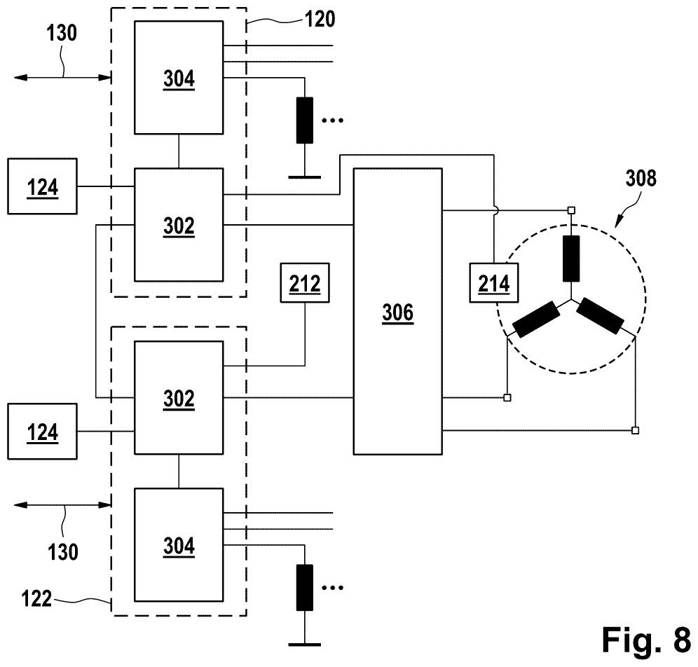

FIG. 8 shows a schematic representation of a second exemplary electrical concept of a brake system 100. In this case, the partitions 120 and 122 each have only a separate closed loop control microcontroller 302 and a separate valve control microcontroller 306, while the motor control microcontroller 304 is provided only as a single unit, and is controlled by both partitions 120 and 122. The architecture shown is based on the consideration that a failure of the motor control microcontroller 304 is unlikely and therefore a redundant design of this function module and thus the increased complexity of the entire brake system 100 is not required. It should be borne in mind here that it is fundamentally not necessary to maintain the ability to generate pressure in the case of every fault within the electromechanical partial brake system 102. For a low error rate, it is acceptable if the ability of the electrohydraulic partial brake system 102 to regulate pressure is lost, provided that the detection of a brake request is still maintained and provided that the electromechanical wheel brakes 112 can still be used.

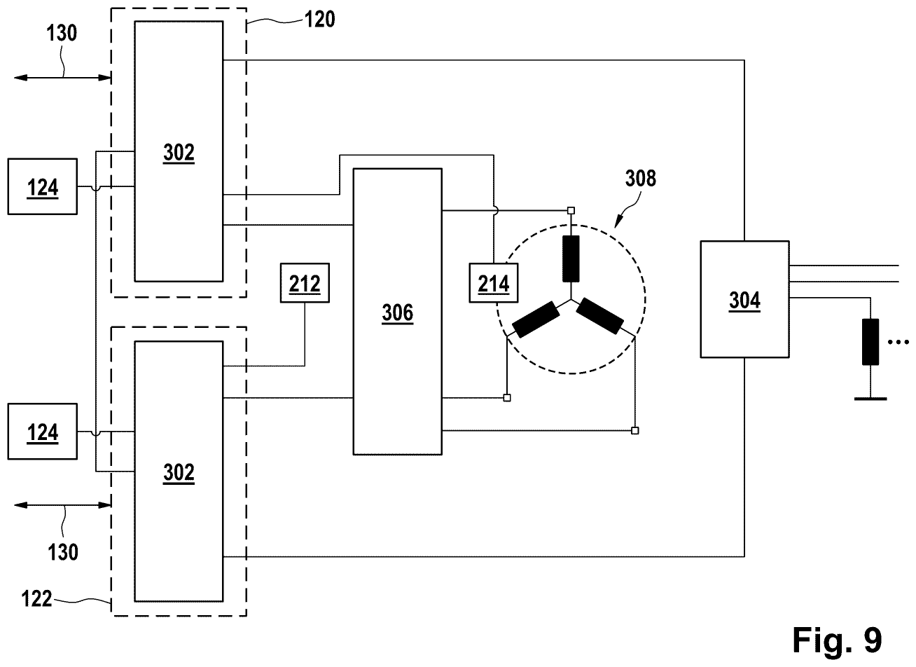

To this end, FIG. 9 shows a schematic representation of a third exemplary electrical concept of a brake system 100, in which this concept is developed even further. Consequently, the partitions 120 and 122 each have only the closed loop control microcontroller 302, while the motor control microcontroller 304 and the valve control microcontroller 306 each are present only once and are used jointly by both partitions 120 and 122. However, it is preferably further provided here that the partitions 120 and 122 can each only actuate the valves assigned to them when using the valve control microcontroller 306. Alternatively, it can also be provided here that both partitions 120 and 122 can each actuate all valves of the brake system 100.

1-21. (canceled)

22. A brake system for a motor vehicle, the brake system comprising:
an electrohydraulic partial brake system;
an electromechanical partial brake system;
a redundant power supply;
an actuating device configured to determine an actuating signal quantifying a brake request as a result of actuation by a vehicle driver;
a brake control unit with at least two independent partitions, wherein each partition is configured to control the electromechanical partial brake system and the electrohydraulic partial brake system on the basis of an actuating signal received from the actuating device.

23. The brake system as set forth in claim 1, wherein the electrohydraulic partial brake system acts on a front axle of the motor vehicle and the electromechanical partial brake system acts on a rear axle of the motor vehicle.

24. The brake system as set forth in claim 1, wherein each independent partition comprises a closed loop control microcontroller for carrying out brake open loop control and brake closed loop control functions on the basis of an actuating signal received from the actuating device.

25. The brake system as set forth in claim 1, wherein the electrohydraulic partial brake system comprises an electric motor-driven pressure provision device for generating a hydraulic brake pressure in hydraulic wheel brakes assigned to the electrohydraulic partial brake system, wherein the pressure provision device may be disconnected hydraulically from the hydraulic wheel brakes by a first pressure sequence valve arranged between the pressure provision device and the wheel brakes.

26. The brake system (100) as set forth in claim 25, wherein both partitions of the brake control unit are configured to actuate the electric motor-driven pressure provision device on the basis of actuation information.

27. The brake system as set forth in claim 26, wherein only the first partition of the brake control unit is configured to actuate the first pressure sequence valve.

28. The brake system as set forth in claim 27, wherein a second pressure sequence valve is arranged between the pressure provision device and the wheel brakes, wherein the second pressure sequence valve is arranged hydraulically parallel to the first pressure sequence valve, and wherein only the second partition is configured to actuate the second pressure sequence valve.

29. The brake system as set forth in claim 25, wherein the electric motor-driven pressure provision device is assigned a motor position sensor for determining an operating parameter of the electric motor, and the hydraulic partial brake system comprises a pressure sensor for determining the hydraulic pressure prevailing in the hydraulic partial brake system, wherein the motor position sensor is connected to the first partition of the brake control unit, and wherein the pressure sensor is connected to the second partition of the brake control unit.

30. The brake system as set forth in claim 25, wherein the hydraulic partial brake system comprises a brake fluid reservoir, wherein two series-connected normally open shut-off valves are arranged between the brake fluid reservoir and the hydraulic wheel brakes, wherein the shut-off valves are configured to controllably interrupt or establish a hydraulic connection between the wheel brakes and the brake fluid reservoir, wherein the first partition of the brake control unit is configured to actuate a first of the shut-off valves, and the second partition of the brake control unit is configured to actuate a second of the shut-off valves.

31. The brake system as set forth in claim 25, wherein the hydraulic wheel brakes are each assigned wheel pressure modulation valves for the wheel-individual modulation of a hydraulic pressure provided by the pressure provision device, and wherein the second partition of the brake control unit is configured to actuate the wheel pressure modulation valves.

32. The brake system as set forth in claim 22, wherein the brake control unit comprises a control microcontroller configured to actuate the components of the electrohydraulic partial brake system, and wherein the first and the second partition are each configured to access the control microcontroller to actuate the elements of the electrohydraulic partial brake system which are assigned to the respective partitions.

33. The brake system as set forth in claim 24, wherein the brake control unit comprises a motor control microcontroller for actuating the electric motor of the electric motor-driven pressure provision device, and the partitions each have a valve control microcontroller for actuating the valves of the electrohydraulic partial brake system, and wherein the first and the second partition are each configured to access the motor control microcontroller to actuate the electric motor of the electric motor-driven pressure provision device.

34. The brake system as set forth in claim 22, wherein the actuating device comprises at least two sensor devices for detecting an actuation of the actuating device, wherein a first of the sensor devices is directly connected to the first partition of the brake control unit, and wherein a second of the sensor devices is directly connected to the second partition of the brake control unit.

35. The brake system as set forth in claim 22, wherein the brake control unit is configured as part of the electrohydraulic partial brake system.

36. The brake system as set forth in claim 22, wherein the first and the second partition of the brake control unit are each connected via a data bus to the electromechanical partial brake system.

37. The brake system as set forth in claim 22, wherein the first and the second partition of the brake control unit are each connected via a communication interface to further control units of the motor vehicle.

38. The brake system as set forth in claim 22, wherein the first partition and the second partition of the brake control unit are connected to each other via a data connection.

39. The brake system as set forth in claim 22, further comprising two independent power sources, wherein a first of the power sources supplies the first partition of the brake control unit with power, and a first of the electromechanical wheel brakes with power, and a second of the power sources supplies the second partition of the brake control unit with power, and a second of the electromechanical wheel brakes with power.

40. The brake system as set forth in claim 22, further comprising two independent power sources and a second control unit, wherein a first of the power sources supplies the first and second partition of the brake control unit with power, and a second of the power sources supplies the electromechanical wheel brakes and the second control unit with power, wherein the second control unit is connected to the brake actuating unit and to the electromechanical and the electrohydraulic brake system for data transmission.

41. The brake system as set forth in claim 40, wherein the second of the power sources is additionally configured to supply the first and second partition of the brake control unit with power, wherein a switching device is provided and configured to switch over the power supply of the first and second partition of the brake control unit between the first and second of the power sources.
